(19) United States
(12) Patent Application Publication
(10) Pub. No.: US 2019/0340845 A1
(43) Pub. Date: Nov. 7, 2019

(54) Reporting System in a Vehicle for Reporting an Incident of the Vehicle, and Method for Reporting an Incident of a Vehicle

(71) Applicant: Bayerische Motoren Werke Aktiengesellschaft, Muenchen (DE)

(72) Inventor: Bernd STERNECKER, Haar (DE)

(21) Appl. No.: 16/512,609

(22) Filed: Jul. 16, 2019

Related U.S. Application Data
(63) Continuation of application No. PCT/EP2018/054708, filed on Feb. 26, 2018.

(30) Foreign Application Priority Data
Mar. 28, 2017 (DE) 10 2017 205 255.4

(51) Int. Cl. G07C 5/00; G07C 5/08; B60R 16/023; G08G 1/127

(52) U.S. Cl. CPC G07C 5/008; G08G 1/127; B60R 16/0232; G07C 5/0816

(57) ABSTRACT

A reporting system in a vehicle for reporting an incident of the vehicle has a communication unit and a control unit which is coupled to the communication unit. The communication unit is configured to receive and transmit signals, and the control unit is configured to trigger the communication unit so as to: receive first keep-alive signals transmitted by a transmission unit according to a specified reception/response pattern and transmit second keep-alive signals to the transmission unit in response to the first keep-alive signals, wherein a deviation from the specified reception/response pattern represents the presence of an incident of the vehicle; and transmit a vehicle information signal to the transmission unit. The vehicle information signal includes at least one of the following items of information: position information of the vehicle; occupancy of the vehicle, state of health of one or more vehicle occupants; position information of a damaged and/or missing part of the vehicle; technical state of the vehicle and/or the vehicle functions; travel parameters and/or vehicle function parameters; surroundings data of the vehicle; and a prognosis of the communication capability of the transmission unit and/or the communication unit.

### CROSS REFERENCE TO RELATED APPLICATIONS

This application is a continuation of PCT International Application No. PCT/EP2018/054708, filed Feb. 26, 2018, which claims priority under 35 U.S.C. § 119 from German Patent Application No. 10 2017 205 255.4, filed Mar. 28, 2017, the entire disclosures of which are herein expressly incorporated by reference.

### BACKGROUND AND SUMMARY OF THE INVENTION

The present invention relates to a reporting system in a vehicle for reporting an incident involving the vehicle, and to a method for reporting an incident involving a vehicle.

The prior art already discloses accident reporting systems that forward relevant information in the event of an accident to a control station, as described for example in DE 10 2008 016 226 A1. These systems are however either triggered by the crash sensors of the vehicle or activated by manual operation by an occupant. These accident reporting systems are therefore not able to be used for the occurrence of a vehicle breakdown or for autonomously or automatically driven vehicles.

The object of the invention is to avoid the abovementioned disadvantages and to provide a solution that makes it possible to report an incident involving the vehicle.

According to a first aspect of the invention, a reporting system in a vehicle for reporting an incident involving the vehicle is provided. The reporting system has a communication unit and a control unit coupled to the communication unit. The communication unit is configured so as to transmit and so as to receive signals. The control unit is configured so as to prompt the communication unit:
to receive first keep-alive signals transmitted from a transmission unit in accordance with a predefined reception response pattern and to transmit second keep-alive signals to the transmission unit in response to the first keep-alive signals, wherein a deviation from the predefined reception response pattern represents the presence of an incident involving the vehicle; and
to transmit a vehicle information signal to the transmission unit, wherein the vehicle information signal comprises at least one of the following items of information:
   position information of the vehicle;
   occupancy of the vehicle;
   state of health of one or more vehicle occupants;
   position information of a damaged and/or missing part of the vehicle;
   technical state of the vehicle and/or of the vehicle functions;
   driving parameters and/or vehicle function parameters;
   surroundings data of the vehicle;
   forecast of the communication capability of the transmission unit and/or of the communication unit.

An incident involving the vehicle is understood to mean a state of the vehicle in which the vehicle is damaged and/or is no longer able to be driven. Such an incident may be for example an accident, a technical defect and/or a breakdown.

The control unit is a unit that receives information, for example in the form of signals and/or data, from a device, processes it and makes it available to a further device or prompts the further device to perform a particular action. To this end, the control unit is connected in terms of communication to one or more devices, such as for example the communication unit. The connection in terms of communication may be a wired or a wireless (for example Bluetooth, WLAN, mobile radio) connection.

The communication unit is connected in terms of communication both to the control unit and to the transmission unit, wherein the connection may be wired or wireless. The communication unit is configured so as to receive and so as to transmit signals.

The communication unit and/or the control unit may be part of an infotainment system of the vehicle. The infotainment system is understood to mean a system that is configured so as to operate and/or execute various functions of the vehicle, such as for example multimedia, navigation system, driver assistance systems and telematics.

The reporting system may have further units, such as for example an output unit for outputting a report.

According to the first aspect of the invention, the control unit is configured so as to prompt the communication unit to receive first keep-alive signals and to transmit second keep-alive signals in response to the first keep-alive signals. The reception of the first keep-alive signals transmitted from the transmission unit by the communication unit and the transmission of the second keep-alive signals by the communication unit is in this case performed in accordance with a predefined reception response pattern. The reception response pattern controls the sequence in which keep-alive signals are received and transmitted. The reception response pattern in particular controls the temporal sequence of the first keep-alive signals and of the second keep-alive signals. While the vehicle is traveling, first keep-alive signals are continuously received and second keep-alive signals are continuously transmitted in response to the respective first keep-alive signals, wherein the reception response pattern controls the sequence thereof.

According to one embodiment, the control unit is configured so as to prompt the communication unit, in accordance with the predefined reception response pattern, to transmit the respective second keep-alive signal to the transmission unit within a predefined time interval after the reception of the respective first keep-alive signal. In other words, the reception response pattern defines a time period that begins to run starting from the time at which the communication unit receives the respective first keep-alive signal transmitted from the transmission unit. The communication unit then transmits the respective second keep-alive signal to the transmission unit within this time period. The reception response pattern thus controls the temporal sequence of the respective first received keep-alive signal and of the subsequent respective second transmitted keep-alive signal.

According to a further embodiment, the predefined time interval between the respective first received keep-alive signal and the respective second transmitted keep-alive signal is at most 30 seconds, preferably at most 15 seconds and particularly preferably at most 5 seconds.

The deviation from the predefined reception response pattern is inferred to be the presence of an incident involving the vehicle. A deviation from the predefined reception response pattern is present when the reception of the respective first keep-alive signal and/or the transmission of the respective second keep-alive signal does not follow the predefined reception response pattern. One example of a deviation from the predefined reception response pattern is for example a delayed or lack of reception of the respective first keep-alive signal and/or a delayed or lack of transmission of the respective second keep-alive signal. Thus, if for example two consecutive first keep-alive signals are received by the communication unit without a second keep-alive signal being transmitted by the communication unit between the first keep-alive signals, a deviation from the predefined reception response pattern is present. A delay in the second keep-alive signal is present for example if the second keep-alive signal is transmitted to the transmission unit 60 seconds, preferably 30 seconds and particularly preferably 10 seconds after the reception of the first keep-alive signal.

In the event of an incident involving the vehicle, in order to immediately take further actions, such as for example establishing contact with an emergency control station or a traffic management system, a vehicle information signal that contains particular information is transmitted by the communication unit to the transmission unit. An item of position information of the vehicle may be determined by a position determination device that detects the current position of the vehicle. The position determination device detects the current position of the vehicle for example using a GPS system, which is preferably integrated in a navigation system, and/or a Galileo system. The occupancy of the vehicle may be detected using seat sensors that are arranged in or on the seats of the vehicle. By way of example, pressure sensors that detect whether or not an occupant is on the seat are installed in the seats. The state of health of one or more vehicle occupants, in particular of the driver, may be determined via health parameters, such as for example heart rate, breathing rate, tiredness and/or dizziness. The health parameters may be determined using an interior camera, using sensors in the vehicle system (for example seat, steering wheel, gearstick, etc.) or the vehicle functions set by the occupants (for example air conditioning system, ventilation, air freshening, etc.). By determining the health parameters, it is possible to evaluate the driving capability, attentiveness and/or the awake/asleep state of the vehicle occupant(s), in particular of the driver.

An item of position information of a damaged and/or missing part of the vehicle may be determined using vehicle sensors or transponders that are installed in the respective parts of the vehicle.

The technical state of the vehicle and/or of the vehicle functions may be determined using a sensor system that monitors the technical data and/or the vehicle functions of the vehicle and possibly stores their evolution. The technical state of the vehicle and/or of the vehicle functions is understood to mean for example the state of the drive, that is to say for example of the engine (for example filling level and temperature of the engine oil, amount and temperature of the coolant, etc.), of the chassis (for example functional capability of the suspension system, of the steering system, of the brakes, etc.), of the vehicle structure or the like. Driving parameters and/or vehicle function parameters are understood to mean data about the driving of the vehicle, such as for example the speed, acceleration, weight, etc., or functions of the vehicle, such as for example assistance by driver assistants, the operation of an infotainment system, etc. Driving parameters and/or vehicle function parameters may be monitored and possibly recorded by a sensor system.

Surroundings data of the vehicle may furthermore be transmitted to the transmission unit. Surroundings data of the vehicle are determined for example by a sensor system that has ultrasound sensors, lidar sensors, radar sensors and/or a camera system.

The forecast of the communication capability of the transmission unit and/or of the communication unit is understood to mean the determination as to whether the communication capability of the transmission unit and/or of the communication unit could be disrupted at present or in the future. The communication capability of the transmission unit and/or of the communication unit is disrupted for example when the communication path, for example a radio communication, between the transmission unit and/or the communication unit is impaired. One example of an impairment of the communication path is the occurrence of a dead spot which may occur for example behind obstacles or due to electromagnetic interference, but also in buildings, tunnels or parking lots.

The forecast of the communication capability is created by compiling and processing data that are determined by the vehicle itself or by one or more external apparatuses. One example of such a forecast are navigation data that are taken from a map provided in the vehicle or in the backend and by way of which points at which dead spots are likely to occur are able to be evaluated and then taken into consideration. A further example is information about the signal strength or the connection quality at the current location of the vehicle or on the route of the vehicle, which information is made available for the forecast of the communication capability.

The vehicle information signal is advantageously transmitted by the communication unit to the transmission unit together with, that is to say at the same time as, the respective second keep-alive signal.

Whenever a new second keep-alive signal is transmitted, an updated vehicle information signal is also transmitted from the communication unit to the transmission unit.

If a deviation from the predefined reception response pattern is present, at least one of the following actions is performed, preferably by the transmission unit and/or the control unit:
transmission of a message, comprising at least the vehicle information signal, to a traffic management system;
transmission of a message, comprising at least the vehicle information signal, to at least one traffic participant;
transmission of a message, comprising at least the vehicle information signal, to an emergency center;
prompting of a warning indication in relation to the incident involving the vehicle; the warning indication may be displayed in or on the vehicle or on an external apparatus, such as for example a screen of a traffic management system;
prompting of a road closure in the surroundings of the position of the vehicle;
prompting of a speed restriction in the surroundings of the position of the vehicle.

According to one embodiment, the control unit is configured so as to prompt the communication unit to transmit an updated vehicle information signal to the transmission unit with each transmitted second keep-alive signal. An updated vehicle information signal is thus continuously transmitted to the transmission unit. In the event that a deviation from the predefined reception response pattern occurs, that is to say the presence of an incident involving the vehicle is inferred, current information about the vehicle are present at the transmission unit and further measures, such as for example notification to a control station, may be taken immediately.

According to a further embodiment, the reporting system is activated when the vehicle is in an automated driving mode. The reporting system is preferably activated only when the vehicle is in an automated driving mode.

The term “automated driving mode”, in the context of the document, may be understood to mean driving with automated longitudinal or transverse guidance or autonomous driving with automated longitudinal and transverse guidance. The term “automated driving mode” comprises automated driving with any desired degree of automation. Exemplary degrees of automation are assisted, partly automated, highly automated or fully automated driving. These degrees of automation have been defined by the German Federal Highway Research Institute (BASt) (see BASt publication “Forschung kompakt” [compact research], 11/2012 edition). In the case of assisted driving, the driver executes the longitudinal or transverse guidance at all times, while the system takes over the respective other functions to a certain extent. In the case of partly automated driving (PAD), the system takes over the longitudinal and transverse guidance for a certain time and/or in specific situations, the driver, as in the case of assisted driving, having to monitor the system at all times. In the case of highly automated driving (HAD), the system takes over the longitudinal and transverse guidance for a certain time, without the driver having to monitor the system at all times; the driver must however be capable, within a given time, of taking over guidance of the vehicle. In the case of fully automated driving (FAD), the system is able to automatically manage driving in all situations for a specific case of application; for this case of application, a driver is no longer necessary. The abovementioned four degrees of automation in accordance with the definition of the BASt correspond to SAE levels 1 to 4 of the SAE J3106 standard (SAE—Society of Automotive Engineering). By way of example, highly automated driving (HAD) in accordance with the BASt corresponds to level 3 of the SAE J3016 standard. Furthermore, SAE J3016 additionally defines SAE level 5 as the highest degree of automation, this not being contained in the definition of the BASt. SAE level 5 corresponds to driverless driving in which the system is able to automatically manage all situations in the same way as a human driver throughout the entire journey; a driver is generally no longer necessary.

The term “automated driving mode” also includes a driving mode in which no driver and/or no occupants are in the vehicle.

If the vehicle is driving in an automated driving mode, then under some circumstances there is no responsible driver or even a passenger who could perform one of the abovementioned actions in the event of an incident involving the vehicle. Using the reporting system, by way of example, it is possible to report an incident involving the vehicle to a traffic management center or an emergency call center/emergency center without requiring any active involvement of a vehicle occupant.

According to a second aspect, a method for reporting an incident involving a vehicle is provided, wherein the method comprises: in accordance with a predefined reception response pattern, receiving first keep-alive signals transmitted by a transmission unit and transmitting second keep-alive signals to the transmission unit in response to the first keep-alive signals by way of a communication unit, wherein a deviation from the predefined reception response pattern represents the presence of an incident involving the vehicle; and transmitting a vehicle information signal to the transmission unit by way of the communication unit, wherein the vehicle information signal comprises at least one of the following items of information:
position information of the vehicle;
occupancy of the vehicle;
state of health of one or more vehicle occupants;
position information of a damaged and/or missing part of the vehicle;
technical state of the vehicle and/or of the vehicle functions;
driving parameters and/or vehicle function parameters;
surroundings data of the vehicle;
forecast of the communication capability of the transmission unit and/or of the communication unit.

According to one embodiment, in accordance with the predefined reception response pattern, the respective second keep-alive signal is transmitted by the communication unit to the transmission unit within a predefined time interval after the reception of the respective first keep-alive signal.

According to a further embodiment, an updated vehicle information signal is transmitted by the communication unit to the transmission unit with each transmitted second keep-alive signal.

According to a further embodiment, the method is performed when the vehicle is in an automated driving mode.

According to a further embodiment, in the presence of a restricted communication capability of the transmission unit and/or of the communication unit, a deviation from the predefined reception response pattern does not represent the presence of an incident involving the vehicle. In other words, an incident involving the vehicle is not inferred if a restriction or a failure of the communication capability of the transmission unit and/or of the communication unit is known. The information as to whether the communication capability is restricted is available to the control unit via the vehicle information signal.

The above embodiments in relation to the reporting system according to the invention in a vehicle for reporting an incident involving the vehicle according to the first aspect of the invention also apply accordingly to the method according to the invention for reporting an incident involving a vehicle according to the second aspect of the invention. Advantageous exemplary embodiments of the method according to the invention that are not explicitly described at this point and in the patent claims correspond to the advantageous exemplary embodiments of the reporting system according to the invention that are described above or that are described in the patent claims.

According to a third aspect of the present invention, the underlying object is achieved by a vehicle that has a reporting system according to one of the embodiments as have been described above.

According to a further embodiment, a device for reporting an incident involving a vehicle is provided, wherein the device has a transmission unit for transmitting first keep-alive signals and a reporting system according to one of the embodiments as have been described above. In this case, the transmission unit may be integrated into a traffic management system and/or an emergency call center/emergency center.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows an exemplary reporting system in a vehicle for reporting an incident involving the vehicle.

### DETAILED DESCRIPTION OF THE DRAWING

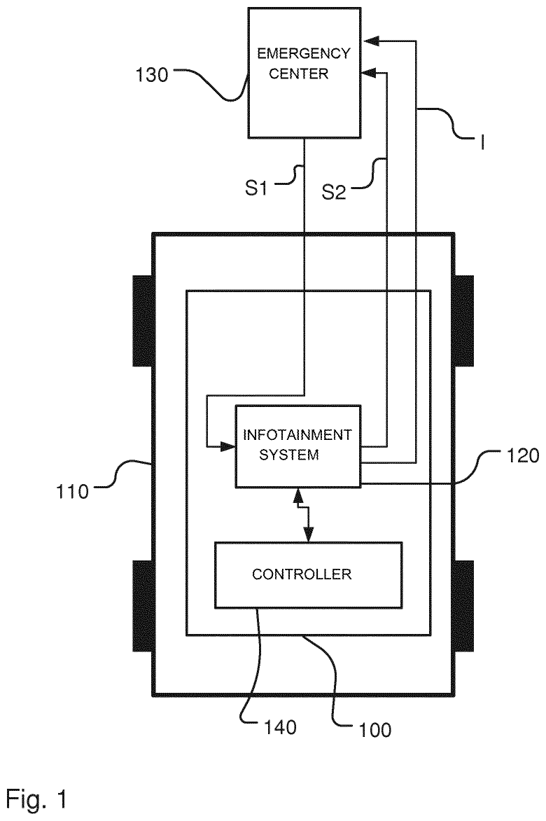

FIG. 1 shows a vehicle 110 that has an exemplary reporting system 100 for reporting an incident involving the vehicle 110. The reporting system 100 has an infotainment system 120 that is coupled to a controller 140 for data transfer purposes. The controller 140 prompts the infotainment system 120 to transmit and to receive signals. In a normal state of the vehicle 110, that is to say when no incident (such as for example a technical defect, a breakdown or an accident) is present, the infotainment system 120 receives first keep-alive signals S1, which are transmitted from an emergency center 130 external to the vehicle at regular intervals, for example every 30 seconds, and transmits second keep-alive signals S2 to the emergency center 130 in response thereto. The second keep-alive signals S2 are transmitted at regular intervals, for example every 5 seconds, to the emergency center 130 after the reception of the first keep-alive signals S1. The communication between the infotainment system 120 and the emergency center 130 external to the vehicle is wireless, for example via a radio connection. The infotainment system 120 furthermore transmits a vehicle information signal I to the emergency center 130 at regular intervals, for example every 30 seconds. The vehicle information signal I comprises the following information: GPS coordinates of the vehicle 110, presence of a technical defect with part of the vehicle 110 or with a vehicle function (such as for example the control system for the airbag or the functional capability of a driver assistance system) and information about the forecast communication capability of the emergency center 130 and/or of the infotainment system 120. The forecast of the communication capability of the emergency center 130 and/or of the infotainment system 120 is determined, inter alia, on the basis of the following data: presence of a disruption in the wireless connection between the infotainment system 120 and the emergency center 130 due to lack of network coverage or network disruption, reduction or lack of radio connection due to geographical circumstances (for example tunnel, forest or mountains), the data of a navigation system internal to the vehicle or a map available outside the vehicle being evaluated for this purpose, presence of a power outage or of a battery failure or of a low battery.

An incident, such as for example a technical defect, a breakdown or an accident involving the vehicle 110, is inferred when a deviation from the predefined reception response pattern, that is to say the reception and transmission of keep-alive signals S1 and S2 at regular intervals, is recorded. If for example the second keep-alive signal S2 is delayed, that is to say for example transmitted to the emergency center 130 40 seconds after the reception of the first keep-alive signal S1, an incident involving the vehicle 110 is inferred.

The information that has been transmitted at regular intervals to the emergency center 130 by the vehicle information signal I allows a conclusion as to what type of incident has occurred. If for example the item of information that the vehicle 110 has an excessively low engine oil state was transmitted to the emergency center 130 with the vehicle information signal I, it is inferred that the vehicle 110 has a technical defect. By evaluating the last transmitted GPS coordinates, it may furthermore be established whether the vehicle 110 has been left stationary. The emergency center 130 may use this information to perform further actions. Such actions comprise for example displaying the item of information that a defective vehicle has been left stationary on a display of a traffic management system and/or displaying a warning that a defective vehicle has been left stationary in the infotainment system of other traffic participants and/or prompting and guiding a breakdown vehicle to the vehicle 110.

If the last vehicle information signal I were however to transmit the item of information to the emergency center 130 that there is a disruption in the communication capability of the infotainment system 120 due to lack of radio network coverage in the example described above, there would not be a deviation from the predefined reception response pattern and an incident involving the vehicle 110 would not be inferred. No further actions would thus be triggered either by the emergency center 130.

An incident involving the vehicle 110 is thus inferred whenever the second keep-alive signal S2 is transmitted to the emergency center 130 more than 30 seconds after the reception of the first keep-alive signal S1 and at the same time there is no disruption in the communication capability of the infotainment system 120.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reporting system in a vehicle for reporting an incident involving the vehicle, the reporting system comprising:
a communication unit that is configured so as to transmit and so as to receive signals;
a control unit that is coupled to the communication unit and that is configured so as to prompt the communication unit to:
receive first keep-alive signals transmitted from a transmission unit in accordance with a predefined reception response pattern and transmit second keep-alive signals to the transmission unit in response to the first keep-alive signals, wherein a deviation from the predefined reception response pattern represents a presence of an incident involving the vehicle; and
transmit a vehicle information signal to the transmission unit, wherein the vehicle information signal comprises at least one of the following items of information:
position information of the vehicle;
occupancy of the vehicle;
state of health of one or more vehicle occupants;
position information of a damaged and/or missing part of the vehicle;
technical state of the vehicle and/or of vehicle functions;
driving parameters and/or vehicle function parameters;
surroundings data of the vehicle;
forecast of a communication capability of the transmission unit and/or of the communication unit.

2. The reporting system according to claim 1, wherein
the control unit is configured so as to prompt the communication unit, in accordance with the predefined reception response pattern, to transmit the respective second keep-alive signal to the transmission unit within a predefined time interval after the reception of the respective first keep-alive signal.

3. The reporting system according to claim 2, wherein
the control unit is configured so as to prompt the communication unit to transmit an updated vehicle information signal to the transmission unit with each transmitted second keep-alive signal.

4. The reporting system according to claim 1, wherein
the reporting system is activated when the vehicle is in an automated driving mode.

5. A method for reporting an incident involving a vehicle, comprising:
in accordance with a predefined reception response pattern, receiving first keep-alive signals transmitted by a transmission unit and transmitting second keep-alive signals to the transmission unit in response to the first keep-alive signals by way of a communication unit, wherein a deviation from the predefined reception response pattern represents a presence of an incident involving the vehicle;
transmitting a vehicle information signal to the transmission unit by way of the communication unit, wherein the vehicle information signal comprises at least one of the following items of information:
position information of the vehicle;
occupancy of the vehicle;
state of health of one or more vehicle occupants;
position information of a damaged and/or missing part of the vehicle;
technical state of the vehicle and/or of vehicle functions;
driving parameters and/or vehicle function parameters;
surroundings data of the vehicle (110);
forecast of a communication capability of the transmission unit (130) and/or of the communication unit (120).

6. The method according to claim 5, wherein
in accordance with the predefined reception response pattern, the respective second keep-alive signal is transmitted by the communication unit to the transmission unit within a predefined time interval after the reception of the respective first keep-alive signal.

7. The method according to claim 6, wherein
an updated vehicle information signal is transmitted by the communication unit to the transmission unit with each transmitted second keep-alive signal.

8. The method according to claim 5, wherein
the method is performed when the vehicle is in an automated driving mode.

9. The method according to claim 5, wherein
in the presence of a restricted communication capability of the transmission unit and/or of the communication unit, a deviation from the predefined reception response pattern does not represent the presence of an incident involving the vehicle.

10. A vehicle, comprising a reporting system according to claim 1.
